(19) United States
(12) Patent Application Publication
(10) Pub. No.: US 2024/0270044 A1
(43) Pub. Date: Aug. 15, 2024

(54) AIR-GUIDING DEVICE FOR AN AIR-CONDITIONING UNIT OF AN AT LEAST PARTIALLY ELECTRICALLY DRIVEN VEHICLE, METHOD FOR OPERATING A SYSTEM, AND VEHICLE

(71) Applicant: Ford Global Technologies, LLC, Dearborn, MI (US)

(72) Inventors: Ingo Krolewski, Neuss (DE); Bart Wilhelmus Schmitz, Köln (DE); Michael Lezuo, Frechen (DE)

(73) Assignee: Ford Global Technologies, LLC, Dearborn, MI (US)

(21) Appl. No.: 18/423,663

(22) Filed: Jan. 26, 2024

(30) Foreign Application Priority Data
Feb. 14, 2023 (DE) 102023103581.9

(51) Int. Cl. B60H 1/00

(52) U.S. Cl. CPC B60H 1/00028; B60H 2001/00085; B60H 2001/0015

(57) ABSTRACT

An air-guiding device for an air-conditioning unit of an at least partially electrically driven vehicle, a method for operating a system, and a vehicle. The air-guiding device comprises at least a first air inlet, a second air inlet, an air outlet, a channel fluidically coupled to the first air inlet, to the second air inlet, and to the air outlet, and at least one valve device. The first air inlet is arranged to allow a fluid flow between an exterior of the vehicle and the channel. The second air inlet is arranged to allow a fluid flow between a technical compartment of the vehicle and the channel. The air outlet is arranged to allow a fluid flow between the channel and the air-conditioning unit. The valve device(s) is arranged such that a fluid flow from the air inlets in the direction of the air outlet can be prevented.

### CROSS-REFERENCE TO RELATED APPLICATION

This application claims foreign priority benefits under 35 U.S.C. § 119(a)-(d) to German Application No. 102023103581.9 filed Feb. 14, 2023, which is hereby incorporated by reference in its entirety.

### FIELD OF THE DISCLOSURE

The present disclosure generally relates to an air-guiding device for an air-conditioning unit of an at least partially electrically driven vehicle, and to a system and method for operating the system, and to a vehicle.

### BACKGROUND OF THE DISCLOSURE

An air-conditioning unit of a vehicle generally serves to provide fresh air for the passenger compartment of the vehicle. The user typically sets a desired temperature. The air-conditioning unit can therefore be operated in a heating mode or a cooling mode (in general: an operating mode) depending on the temperature of the exterior of the vehicle. The operating mode of the air-conditioning unit is generally dependent on whether the user desires a temperature for the passenger compartment that is higher or lower than the temperature of the exterior of the vehicle. In order to adjust the temperature of the fresh air that is provided by the air-conditioning unit in accordance with the user input, the air-conditioning unit typically has at least a heating device and a cooling device or a combination device for both operating modes, for example an exterior heat exchanger. As a result, the air-conditioning unit contributes to the energy consumption by the vehicle, which ultimately reduces the range of the vehicle.

Conventional vehicles have the internal combustion engine in the engine compartment in the front part of the vehicle, beneath the engine hood. Since the internal combustion engine and further devices that are arranged in the engine compartment, such as heating elements, for example, constitute sources of heat, some known air-conditioning units propose drawing the feed air at least partially from the engine compartment. Owing to the use of the warm feed air from the engine compartment, the energy consumption by the air-conditioning unit can be reduced since heating up of the feed air drawn in from the engine compartment can be reduced or can be dispensed with. However, since the air from the engine compartment may be comparatively impure, for example due to films of operating medium that may occur in the engine compartment, extensive and complex filtering measures (odor and particle filters) are commonly employed. This means that even though an energy saving can be realized, this energy saving is associated with an uneconomically high degree of complexity that is required for filtering the drawn-in air.

It would be desirable to provide an air-guiding device which allows reduced consumption of operating medium in comparison to known systems, so that an increase in the range of the vehicle is rendered possible.

### SUMMARY OF THE DISCLOSURE

According to a first aspect of the present disclosure, an air-guiding device for an air-conditioning unit of an at least partially electrically driven vehicle comprises a first air inlet, a second air inlet, an air outlet, a channel fluidically coupled to the first air inlet, to the second air inlet, and to the air outlet, and at least one valve device. The first air inlet of the device is arranged to allow a fluid flow between an exterior of the vehicle and the channel. The second air inlet of the device is arranged to allow a fluid flow between a technical compartment of the vehicle and the channel the air outlet is arranged to allow a fluid flow between the channel and the air-conditioning unit. At least one valve device is arranged such that a fluid flow starting from the first air inlet and/or from the second air inlet in a direction of the air outlet can be prevented.

Embodiments of the first aspect of the present disclosure can include any one or a combination of the following features:
the at least one valve device comprises a first valve device and a second valve device arranged separately such that a fluid flow starting from the first air inlet or from the second air inlet in the direction of the air outlet can be prevented by use of the respective first and second valve devices;
a third valve device arranged such that a fluid flow starting from the first air inlet and from the second air inlet in the direction of the air outlet can be prevented by use of the third valve device;
each valve device of the at least one valve device is assigned an actuator which can be coupled to a control device of the air-conditioning unit for receiving an actuating signal, which defines a position of the respective each valve device; and
the first air inlet is designed to be positioned in a manner adjoining a front hood of the vehicle.

According to a second aspect of the present disclosure, an at least partially electrically driven vehicle comprises an air-conditioning unit and an air-guiding device which is fluidically coupled to the air-conditioning unit. The air-guiding device has a first air inlet, a second air inlet, an air outlet, a channel fluidically coupled to the first air inlet, to the second air inlet, and to the air outlet, and at least one valve device. The first air inlet of the valve device is arranged to allow a fluid flow between an exterior of the vehicle and the channel. The second air inlet of the valve device is arranged to allow a fluid flow between a technical compartment of the vehicle and the channel. The air outlet of the at least one valve device is arranged to allow a fluid flow between the channel and the air-conditioning unit. The at least one valve device is arranged such that a fluid flow starting from the first air inlet and/or from the second air inlet in the direction of the air outlet can be prevented.

Embodiments of the second aspect of the present disclosure can include any one or a combination of the following features:
the at least one valve device comprises a first valve device and a second valve device arranged separately such that a fluid flow starting from the first air inlet or from the second air inlet in the direction of the air outlet can be prevented by use of the respective first and second valve devices;
a third valve device arranged such that a fluid flow starting from the first air inlet and from the second air inlet in the direction of the air outlet can be prevented by use of the third valve device;
each valve device of the at least one valve device is assigned an actuator which can be coupled to a control device of the air-conditioning unit for receiving an actuating signal, which defines a position of the respective each valve device;
the first air inlet is designed to be positioned in a manner adjoining a front hood of the vehicle;
the air-conditioning unit has a control device designed to output an actuating signal, which defines a position of the at least one valve device, to at least one actuator which is assigned to the at least one valve device; and
the air-conditioning unit further comprises at least one temperature sensor coupled to the control device and designed to transmit temperature measurement values to the control device, wherein the control device is designed to receive at least one user input from a human/machine interface, and wherein the control device is further designed to provide the actuating signal to the at least one actuator depending on the user input and the received temperature measurement values.

According to a third aspect of the present disclosure, a method for operating a system comprises an air-conditioning unit for an at least partially electrically driven vehicle, and an air-guiding device which is fluidically coupled to the air-conditioning unit. The air-guiding device has a first air inlet, a second air inlet, an air outlet, a channel fluidically coupled to the first air inlet, to the second air inlet, and to the air outlet, and has at least a first and a second valve device. The first valve device is arranged such that a fluid flow starting from the first air inlet in the direction of the air outlet can be prevented by use of the first valve device, the second valve device is arranged such that a fluid flow starting from the second air inlet in the direction of the air outlet can be prevented by use of the second valve device, and each of the first and second valve devices is assigned an actuator which is coupled to a control device of the air-conditioning unit for the purpose of receiving an actuating signal which defines a position of the respective first and second valve devices. A method for operating a system is provided. The method includes the steps of outputting an actuating signal to the actuator that is assigned to the first valve device in such a way that only the fluid flow starting from the first air inlet in the direction of the air outlet is prevented by use of the first valve device for a heating mode of the air-conditioning unit, or outputting a different actuating signal to the actuator that is assigned to the second valve device in such a way that only the fluid flow starting from the second air inlet in the direction of the air outlet is prevented by use of the second valve device for a cooling mode of the air-conditioning unit.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a simplified schematic side view illustration of a vehicle having a system including an air-guiding device and an air-conditioning unit, according to one embodiment;

FIG. 2 is a simplified schematic illustration of the system, according to one embodiment; and

FIG. 3 is a flow chart illustrating a method for operating the system, according to one embodiment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

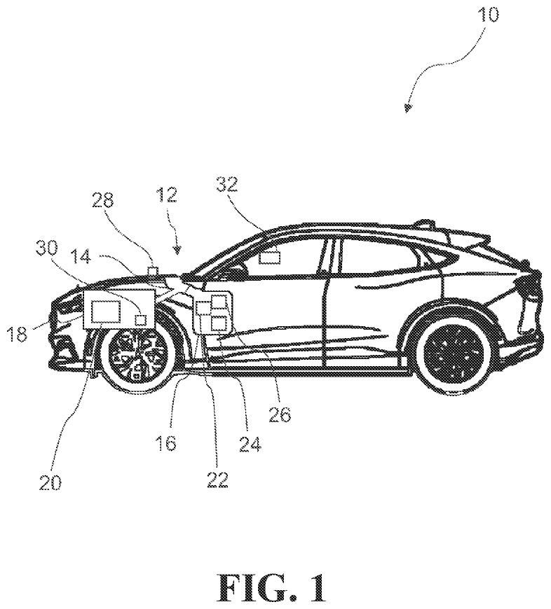

FIG. 1 shows a simplified schematic illustration of a vehicle 10 having a system 12 according to one embodiment. The system 12 comprises an air-guiding device 14 and an air-conditioning unit 16. The vehicle 10 is a motor vehicle such as an electric vehicle that is at least partially electrically driven. A technical compartment 18 is arranged in the front region of the vehicle 10 beneath a front hood, in the present embodiment an electric motor 20 being arranged in the technical compartment in addition to other devices.

According to this embodiment, the air-conditioning unit 16 has a control device 22, a heating device 24 and a cooling device 26. In the present embodiment, the system 12 additionally comprises a first temperature sensor 28 and a second temperature sensor 30. The first temperature sensor 28 and the second temperature sensor 30 are coupled to the control device 22 of the air-conditioning unit 16. The first temperature sensor 28 is arranged in such a way that it is designed to detect a temperature in an exterior 38 relative to the vehicle 10. The second temperature sensor 30 is arranged in such a way that it is designed to detect a temperature in the technical compartment 18 of the vehicle 10. The first temperature sensor 28 and the second temperature sensor 30 transmit detected temperature measurement values to the control device 22.

According to this embodiment, the vehicle 10 additionally has a human/machine interface 32 which is arranged in the passenger compartment and is designed as a multifunctional display such as a touchscreen display that also serves as a user input device to receive user inputs. The human/machine interface 32 is likewise coupled to the control device 22 of the air-conditioning unit 16.

The control device 22 is additionally designed to receive user inputs by a vehicle user, in particular those user inputs that have an effect on the air-conditioning of the passenger compartment of the vehicle 10 by use of the air-conditioning unit 16, from the human/machine interface 32.

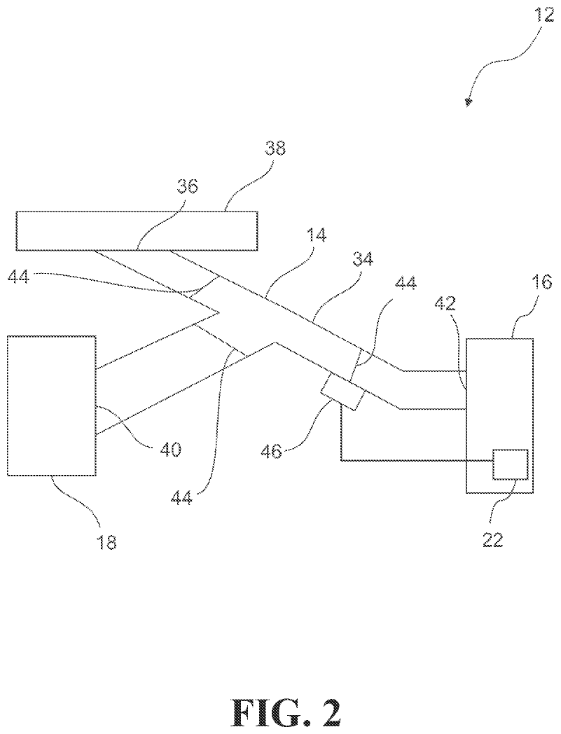

The air-guiding device 14 provides a fluidic connection firstly between the exterior 38 and the air-conditioning unit 16 and secondly between the technical compartment 18 and the air-conditioning unit 16. This will be explained in detail with respect to FIG. 2.

FIG. 2 shows a simplified schematic illustration of the system 12 according to one embodiment. The air-guiding device 14 comprises a channel 34, a first air inlet 36 and a second air inlet 40. The first air inlet 36 delimits the air-guiding device 14 with respect to an exterior 38 of the vehicle 10, the exterior being only schematically indicated here. The second air inlet 40 delimits the air-guiding device 14 with respect to the technical compartment 18 of the vehicle 10.

Even though the first air inlet 36 and the second air inlet 40 are illustrated using solid lines in the present embodiment illustrated, the air inlets 36, 40 generally naturally have a perforation and are gas-permeable, in particular air-permeable. In this respect, the first air inlet 36 ensures a fluidic connection between the exterior 38 and the channel 34 of the air-guiding device 14. Accordingly, the second air inlet 40 ensures a fluidic connection between the technical compartment 18 and the channel 34.

The air-guiding device 14 further comprises an air outlet 42, which delimits the air-guiding device 14 with respect to the air-conditioning unit 16, in particular an inlet of the air-conditioning unit. The air outlet 42 also has a corresponding perforation and is gas-permeable, in particular air-permeable. The air outlet 42 ensures a fluidic connection between the channel 34 and the air-conditioning unit 16. The channel 34 of the air-guiding device 14 allows a fluidic connection between the first air inlet 36, the second air inlet 40 and the air outlet 42.

In order to be able to influence the fluid flow inside the air-guiding device 14 as required depending on the respective reservoir, that is to say the exterior 38 or the technical compartment 18, several valve devices 44 are arranged inside the channel 34, according to this embodiment.

The valve devices 44 can generally assume an open position, a closed position or intermediate positions. Therefore, a fluid flow across the respective valve device 44 can either be maximized or minimized (suppressed) or influenced as required, in particular limited.

A first valve device 44 is arranged inside a channel section that leads to the first air inlet 36. A fluid flow starting from the exterior 38 of the vehicle 10 in the direction of the air outlet 42 can therefore be influenced depending on the position of this first valve device 44.

A second valve device 44 is arranged inside a channel section that leads to the second air inlet 40. A fluid flow starting from the technical compartment 18 of the vehicle 10 in the direction of the air outlet 42 can therefore be influenced depending on the position of this second valve device 44.

A third valve device 44 is arranged inside a channel portion that leads to the air outlet 42. A fluid flow starting from the channel 34 to the air-conditioning unit 16 can therefore be influenced depending on the position of this third valve device 44. This means that a fluid flow for the air-conditioning unit 16 can be entirely suppressed.

The present embodiment with three separate valve devices 44 is purely optional. However, the air-guiding device 14 has at least one valve device 44, for use such that the fluid flow through the channel 34 can be influenced.

In the present embodiment, each valve device 44 is assigned an actuator 46, this being illustrated only for one valve device 44 in FIG. 2. The actuators 46 are coupled to the control device 22 of the air-conditioning unit 16. The actuators 46 receive corresponding actuating signals from the control device 22, operation of the actuators 46 being controlled based on the actuating signals. Since each actuator 46 is coupled separately to a valve device 44, the actuating signals received by the actuators 46 define a specific deflection of the respective valve device 44.

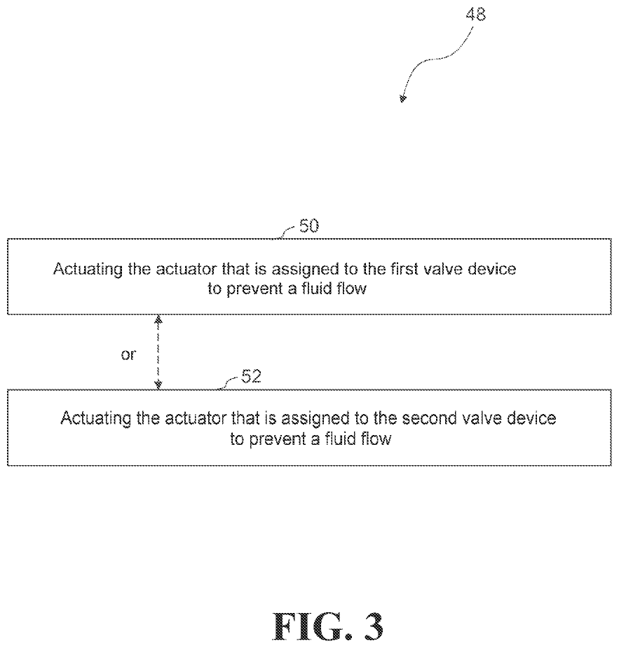

FIG. 3 shows a simplified schematic illustration of a method 48 for operating a system 12 according to one embodiment. According to this embodiment, the system 12 comprises at least two valve devices 44. A first valve device 44 acts in respect of the fluid flow starting from the first air inlet 36 and a second valve device 44 acts in respect of the fluid flow starting from the second air inlet 40.

The control device 22 optionally receives a user input, on the basis of which a desired interior temperature of the passenger compartment of the vehicle 10 is defined, via the human/machine interface 32. In addition, the control device 22 preferably receives temperature measurement values from the temperature sensors 28, 30.

The control device 22 determines whether the air-conditioning unit 16 has to be operated in a heating mode or a cooling mode depending on the temperature of the exterior 38 of the vehicle 10 and the user input using the human/machine interface 32. In other words, the control device 22 can determine whether air drawn from the exterior 38 has to be heated in order to ensure the desired prespecified temperature for the passenger compartment of the vehicle 10 on the basis of the received measurement values and the user input.

For the heating mode of the air-conditioning unit 16, the control device 22 can then draw in particular a fluid flow primarily or only from the technical compartment 18 of the vehicle 10. In other words, a fluid flow starting from the exterior 38 of the vehicle 10 can be at least partially suppressed if the temperature in the exterior 38 would require an additional temperature increase by use of a heating device 24 of the air-conditioning unit 16. In this case, according to step 50, an actuating signal is output by the control device 22 to the actuator of that valve device 44 which is arranged inside the channel section that leads to the first air inlet 36. This valve device 44 can consequently be closed, as a result of which a fluid flow across this valve device 44 starting from the exterior 38 is suppressed. This ensures that a fluid flow primarily or only starting from the technical compartment 18 is rendered possible. Since the technical compartment 18 is generally at a temperature that lies above that of the exterior 38 in any case, the requirement for heating the air by use of the air-conditioning unit 16 can thus be advantageously reduced. This allows an energy saving in terms of heating air. This leads to an increase in range for the at least partially electrically driven vehicle 10.

Accordingly, the control device 22 can also determine that the air-conditioning unit 16 can be operated in a cooling mode depending on the user input to the human/machine interface 32 and the temperature measurement values from the temperature sensors 28, 30. In this embodiment, it is advantageous from an energy point of view to not draw any air from the technical compartment 18, at least if this air is at a temperature that is higher than the temperature in the exterior 38 of the vehicle 10. Accordingly, in step 52, an actuating signal can be output by the control device 22 to that valve device 44 which is arranged inside the channel section that leads to the second air inlet 40. This valve device 44 can consequently be closed, as a result of which a fluid flow starting from the technical compartment 18 is minimized or suppressed. A fluid flow primarily or only starting from the exterior 38 can therefore be rendered possible. As a result, the requirements for temperature cooling by use of the air-conditioning unit 16 are reduced. Consequently, the energy consumption by the air-conditioning unit 16 can also be reduced in the cooling mode.

The system 12 or the method 48 can optionally also be developed by way of mixed configurations being made possible. This means that valve devices 44 each with associated actuators 46 are controlled by the control device 22 in such a way that fluid flows starting from the first air inlet 36 and from the second air inlet 40 are both partially allowed and partially limited. In other words, the valve devices 44 then assume intermediate positions between the open and the closed position. On account of the temperature measurement values received by the control device 22, the control device 22 can control the fluid flows in such a way that the resulting total fluid flow is at a temperature such that the energy consumption for adjusting the temperature by use of the air-conditioning unit 16 is reduced, and in particular is minimized. The temperature of the total fluid flow is then adjusted in the best possible manner to the temperature selection prespecified by the user input. As a result, the energy management of the air-conditioning unit 16 is optimized.

Certain embodiments disclosed here, in particular the control device 22, the human/machine interface 32 and the actuators 46 use electrical circuits (e.g., one or more electrical circuits) to implement standards, protocols, methods or technologies disclosed here, to functionally couple two or more components, to generate information, to process information, to analyze information, to generate signals, to code/decode signals, to convert signals, to transmit and/or to receive signals, to control other units etc. It should be appreciated that circuits of any type can be used.

In one embodiment, a circuit such as the control device 22 comprises, amongst others, one or more data processing devices such as a processor (e.g. a microprocessor), a central processor unit (CPU), a digital signal processor (DSP), an application-specific integrated circuit (ASIC), a field-programmable gate array (FPGA), a system on a chip (SoC) or the like or any desired combinations thereof and can comprise discrete digital or analog circuit elements or electronics or combinations thereof. In one embodiment, the circuit comprises hardware circuit implementations (e.g. implementations in analog circuits, implementations in digital circuits and the like as well as combinations thereof).

In one embodiment, electrical circuits comprise combinations of electrical circuits and computer program products with software or firmware instructions that are stored in one or more computer-readable memories and interact in order to prompt a unit to execute one or more of the protocols, methods or technologies described here. In one embodiment, the circuit technology comprises electrical circuits, such as, e.g., microprocessors or parts of microprocessors which require software, firmware and the like for operation. In one embodiment, the electrical circuits comprise one or more processes or parts thereof and the associated software, firmware, hardware and the like.

In the present disclosure, reference may be made to amounts and numbers. Unless expressly indicated, such amounts and numbers should not be regarded as limiting, but rather as examples of the possible amounts or numbers in association with the present application. In this context, the term “plurality” may also be used in the present application to refer to an amount or a number. In this context, the term “plurality” means any number that is greater than one, e.g. two, three, four, five, etc. The terms “about”, “approximately”, “close to” etc. mean plus or minus 5% of the indicated value.

Although the disclosure has been illustrated and described with reference to one or more embodiments, a person skilled in the art will be able to make equivalent changes and modifications after reading and understanding this description and the appended drawings.

In this disclosure, some aspects are explained with respect to devices, and others with respect to methods. However, the aspects can be correspondingly exchanged.

One aspect provides an air-guiding device for an air-conditioning unit of an at least partially electrically driven vehicle. The air-guiding device comprises at least a first air inlet, a second air inlet, an air outlet, a channel, which is fluidically coupled to the first air inlet, to the second air inlet and to the air outlet, and at least one valve device. The first air inlet is arranged in such a way that it allows a fluid flow between an exterior of the vehicle and the channel. The second air inlet is arranged in such a way that it allows a fluid flow between a technical compartment of the vehicle and the channel. The air outlet is arranged in such a way that it allows a fluid flow between the channel and the air-conditioning unit. The at least one valve device is arranged in such a way that a fluid flow starting from the first air inlet and/or from the second air inlet in the direction of the air outlet can be prevented.

In electrically driven vehicles, the internal combustion engine in the front part of the interior of the vehicle, what is known as the engine compartment in the case of vehicles with an internal combustion engine, is dispensed with. In at least partially electrically driven vehicles, the electric motor used for driving purposes can be arranged in the front part of the vehicle (referred to as the technical compartment in the text which follows), beneath the front hood. In addition to the electric motor, additional heat sources, such as heating devices for example, are typically arranged in this technical compartment. This means that electrically driven vehicles also have a technical compartment beneath the front hood, the technical compartment having various heat sources. Consequently, the temperature within the technical compartment is typically higher than in an exterior of the vehicle. However, by doing away with an internal combustion engine, the essential sources of impurities in the air inside the technical compartment are also missing from the technical compartment. This means that the air inside the technical compartment in vehicles with an electric motor per se typically have a higher air purity than is the case in engine compartments of vehicles with an internal combustion engine.

The air-guiding device of the present disclosure makes use of this. Firstly, an air inlet of the air-guiding device is coupled to an exterior of the vehicle and secondly a further air inlet is coupled to the technical compartment of the at least partially electrically driven vehicle. The valve device is used to suppress at least one fluid flow starting from one of the air inlets as required. This creates an air-guiding device which provides the possibility of drawing feed air for an air-conditioning unit from different reservoirs (exterior vs. technical compartment), which are generally at different temperatures. The reservoir from which the feed air is drawn in this case can be adjusted using the valve device. Consequently, the requirements for adjusting the temperature of the feed air to be performed by the air-conditioning unit can be reduced. This means that less energy has to be expended in order to adjust the temperature of the drawn-in air to a desired temperature.

The gain in efficiency in respect of energy consumption is achieved by the present air-guiding device without the disadvantages of known air-conditioning units occurring in the process, specifically the disadvantage of increased complexity for ensuring the air purity. Since the air purity in technical compartments of electrically driven vehicles is typically higher than in comparable engine compartments of vehicles with an internal combustion engine, additional filtering measures can advantageously be reduced (compared to feed air being formed from the engine compartment of a vehicle with an internal combustion engine) or even averted in spite of the feed air being drawn from the technical compartment. In other words, the reduced energy consumption can be ensured without being raised again due to uneconomically high additional filtering complexity.

Furthermore, the reduced energy consumption in electrically driven vehicles has a direct effect on the range of the vehicle, the range advantageously being increased by use of the air-guiding device as described here in comparison to an air-guiding device which draws the feed air only from the exterior of the vehicle.

Since electric motors require reduced installation space in comparison to internal combustion engines, the gain in installation space can be used to make the vehicle more compact. Since, owing to the more compact construction, the available installation space for the air inlet adjacent to the front hood of the vehicle is also reduced, the present air-guiding device additionally combines the need to again increase the cross-sectional area of the air inlet overall and in so doing to even allow a reduction in the energy consumption by the downstream air-conditioning unit. For this purpose, the air-guiding device has two separate air inlets in the present embodiment, one of which is coupled to the exterior of the vehicle and one of which is coupled to the technical compartment of the vehicle. This ensures that enough feed air for the air-conditioning unit can be drawn and nevertheless the energy consumption can be reduced.

In the present disclosure, fluidic coupling is to be understood to mean that a fluid flow between the fluidically coupled components is possible. In the present embodiment, the fluid preferably comprises a gaseous medium, in particular air. The fluid flow is optionally formed by an air flow.

In one embodiment, the air-guiding device has at least one additional valve device. In this embodiment, each valve device is arranged separately in such a way that a fluid flow starting from the first air inlet or from the second air inlet in the direction of the air outlet can be prevented by use of the respective valve device. This means that a separate valve device is provided for each air inlet. As a result, the fluid flow which results in the air-guiding device can be influenced as required, for example can even be entirely suppressed.

In some embodiments, the air-guiding device has at least one further valve device. The further valve device is arranged in such a way that a fluid flow starting from the first air inlet and from the second air inlet in the direction of the air outlet can be prevented by use of the further valve device. The further valve device can be provided in addition to valve devices already provided for each inlet. The further valve device therefore ensures a redundancy if a fluid flow through the air-guiding device is intended to be entirely suppressed. For example, it is conceivable that neither air from the technical compartment nor from an exterior of the vehicle is intended to be drawn, but rather merely interior air from the passenger compartment of the vehicle is intended to be recirculated by the air-conditioning unit. In this case, the further valve device ensures a high degree of leak tightness of the air-guiding device with respect to the technical compartment and the exterior of the vehicle.

Each valve device is optionally assigned an actuator, which can be coupled to a control device of the air-conditioning unit for the purpose of receiving an actuating signal, which defines a position of the respective valve device. Here, the actuator serves as a drive for the valve device, which can be moved at least between an open and a closed position based on the actuator. In the open position, a maximum fluid flow across the respective valve device is rendered possible. In the closed position, the fluid flow occurring across the valve device is minimized or even suppressed. Therefore, the fluid flow occurring across the valve device can be adjusted as required.

As an alternative or in addition, the actuating signal can also define a position of the actuator. Owing to the coupling of the actuator to the valve device, the thus defined position of the actuator continues directly into a defined position of the valve device.

In some embodiments, a valve device can also assume intermediate positions between an open and a closed position. An actuator that is assigned to the valve device can correspondingly assume intermediate positions of an available movement space of the actuator between opposing end stops. An actuating signal that is received by the actuator can specify the respective intermediate position. Therefore, the variability with respect to the respectively ensured fluid flow across the respective valve device is further increased.

The first air inlet may be designed in such a way that it can be positioned in a manner adjoining a front hood of the vehicle. This prevents complex design measures being required in order to be able to integrate the air-guiding device into the vehicle.

In addition, a further aspect provides a system comprising an air-conditioning unit for an at least partially electrically driven vehicle and an air-guiding device as described above, which is fluidically coupled to the air-conditioning unit.

The advantages achieved with regard to the air-guiding device are correspondingly also ensured by the system. In particular, the energy consumption by the air-conditioning unit can be reduced by the air-guiding device formed in this way, as a result of which the range of the at least partially electrically driven vehicle is ultimately increased.

The air-conditioning unit may have at least a heating device and a cooling device or is coupled to a heating device and a cooling device. The heating device or the cooling device can also be external to the air-conditioning unit. For example, the heating device can be arranged in the technical compartment of the vehicle.

The air-conditioning unit optionally has a control device, which is designed to output an actuating signal, which defines a position of the at least one valve device, to at least one actuator which is assigned to the at least one valve device. As a result, the valve device can be controlled as desired. Therefore, the fluid flow can be influenced.

In some embodiments, the system further has at least one temperature sensor, which is coupled to the control device and is designed to transmit temperature measurement values to the control device. The control device is designed to receive at least one user input from a human/machine interface. The control device is further designed to provide the actuating signal to the at least one actuator depending on the user input and the received temperature measurement values. A temperature requirement, which is to be fulfilled by the air-conditioning unit, is defined by the user input. Based on the temperature measurement values received by the temperature sensor, the control device is then advantageously designed to ensure a fluid flow inside the air-guiding device in such a way that energy consumption by the air-conditioning unit for adjusting the temperature of the drawn-in air is minimized. In other words, the control device can then control the at least one valve device as required depending on the received temperature measurement values and the user input in such a way that the temperature of the air provided for the air-conditioning unit is already optimally adjusted to the user input. Therefore, the temperature requirement that is determined by the user input can be ensured in an energy-efficient manner.

The human/machine interface may be, for example, a multifunctional display of a vehicle, such as a touchscreen display with user inputs, the user input being made via the multifunctional display.

The temperature sensor can optionally be coupled either to an exterior of the vehicle or to the technical compartment in such a way that it can detect a temperature of the air in the exterior of the vehicle or of air inside the technical compartment of the vehicle. The temperature sensor is preferably coupled to an exterior of the vehicle in one embodiment.

The system can optionally also comprise a plurality of temperature sensors. For example, a first temperature sensor can be designed to be able to detect the temperature of the air of an exterior of the vehicle. A second temperature sensor can be designed to be able to detect the temperature of the air inside the technical compartment of the vehicle. All the temperature sensors can be coupled to the control device for transmitting temperature measurement values.

In addition, a further aspect provides a method for operating a system comprising an air-conditioning unit for an at least partially electrically driven vehicle and an air-guiding device, which is fluidically coupled to the air-conditioning unit. The air-guiding device has at least a first and a second valve device. The first valve device is arranged in such a way that a fluid flow starting from the first air inlet in the direction of the air outlet can be prevented by use of the first valve device. The second valve device is arranged in such a way that a fluid flow starting from the second air inlet in the direction of the air outlet can be prevented by use of the second valve device. Each valve device is assigned an actuator, which is coupled to a control device of the air-conditioning unit for the purpose of receiving an actuating signal, which defines a position of the respective valve device. The method comprises the following steps:
an actuating signal is output to the actuator that is assigned to the first valve device in such a way that only the fluid flow starting from the first air inlet in the direction of the air outlet is prevented by use of the first valve device for a heating mode of the air-conditioning unit; or
a different actuating signal is output to the actuator that is assigned to the second valve device in such a way that only the fluid flow starting from the second air inlet in the direction of the air outlet is prevented by use of the second valve device for a cooling mode of the air-conditioning unit.

This means that the air-conditioning unit has different operating modes. The air-conditioning unit can firstly be operated in a heating mode and secondly in a cooling mode. The air in the technical compartment of the at least partially electrically driven vehicle is typically at a higher temperature than is the case for the air in an exterior of the vehicle. The present method advantageously makes use of this temperature difference.

Therefore, air is drawn only from the technical compartment of the vehicle for a heating mode of the air-conditioning unit, that is to say in the case that the air-conditioning unit is intended to provide air at a comparatively high temperature, in particular a temperature that is higher than the temperature of the exterior of the vehicle, for the passenger compartment in any case. For this purpose, the first valve device, which can influence the fluid flow between an exterior of the vehicle and the channel, is closed, so that this fluid flow is prevented.

In the cooling mode of the air-conditioning unit, the air-conditioning unit is intended to provide air at a comparatively low temperature for the passenger compartment. In this mode, the second valve device is used in order to suppress a fluid flow between the second air inlet and the channel. The feed air for the air-conditioning unit is consequently drawn only from the exterior of the vehicle. Therefore, the air-conditioning unit can be operated in an energy-efficient manner by influencing the valve devices.

The choice of operating mode can optionally depend on a user input by a vehicle user to a human/machine interface.

In addition, a further aspect provides a vehicle, which is at least partially electrically driven. The vehicle has an air-guiding device as described above. As an alternative or in addition, the vehicle has a system as described above. In addition or as an alternative, the vehicle has a system, which is operated in accordance with the method as described above. The advantages described with respect to the air-guiding device and the system are correspondingly ensured for the vehicle. In particular, a vehicle for which the range is increased is provided.

For the purposes of the present disclosure, at least partially electrically driven vehicles can include, in particular, land vehicles, specifically, amongst others, off-road and road vehicles such as passenger cars, buses, heavy goods vehicles and other utility vehicles, rail vehicles (trains), but also watercraft (boats) and aircraft such as helicopters, multicopters, propeller planes and jet planes, which have at least one electric motor that serves to propel the vehicle. Vehicles may be manned or unmanned. In addition to fully electric vehicles (BEV), hybrid electric vehicles (HEV) and plug-in hybrids (PHEV) may also be included.

It should be appreciated that all features explained with regard to the various aspects can be combined with other aspects individually or in (sub)combination.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An air-guiding device for an air-conditioning unit of an at least partially electrically driven vehicle, the air-guiding device comprising:
a first air inlet;
a second air inlet;
an air outlet;
a channel fluidically coupled to the first air inlet, to the second air inlet, and to the air outlet; and
at least one valve device, wherein:
the first air inlet is arranged to allow a fluid flow between an exterior of the vehicle and the channel;
the second air inlet is arranged to allow a fluid flow between a technical compartment of the vehicle and the channel;
the air outlet is arranged to allow a fluid flow between the channel and the air-conditioning unit; and
the at least one valve device is arranged such that a fluid flow starting from the first air inlet and/or from the second air inlet in a direction of the air outlet can be prevented.

2. The air-guiding device according to claim 1, wherein the at least one valve device comprises a first valve device and a second valve device arranged separately such that a fluid flow starting from the first air inlet or from the second air inlet in the direction of the air outlet can be prevented by use of the respective first and second valve devices.

3. The air-guiding device according to claim 2, further comprising a third valve device arranged such that a fluid flow starting from the first air inlet and from the second air inlet in the direction of the air outlet can be prevented by use of the third valve device.

4. The air-guiding device according to claim 1, wherein each valve device of the at least one valve device is assigned an actuator which can be coupled to a control device of the air-conditioning unit for receiving an actuating signal, which defines a position of the respective each valve device.

5. The air-guiding device according to claim 1, wherein the first air inlet is designed to be positioned in a manner adjoining a front hood of the vehicle.

6. An at least partially electrically driven vehicle comprising:
an air-conditioning unit; and
an air-guiding device which is fluidically coupled to the air-conditioning unit, the air-guiding device comprising:
a first air inlet;
a second air inlet;
an air outlet;
a channel fluidically coupled to the first air inlet, to the second air inlet, and to the air outlet; and
at least one valve device, wherein:
the first air inlet is arranged to allow a fluid flow between an exterior of the vehicle and the channel;
the second air inlet is arranged to allow a fluid flow between a technical compartment of the vehicle and the channel;
the air outlet is arranged to allow a fluid flow between the channel and the air-conditioning unit; and
the at least one valve device is arranged such that a fluid flow starting from the first air inlet and/or from the second air inlet in the direction of the air outlet can be prevented.

7. The at least partially electrically driven vehicle according to claim 6, wherein the at least one valve device comprises a first valve device and a second valve device arranged separately such that a fluid flow starting from the first air inlet or from the second air inlet in the direction of the air outlet can be prevented by use of the respective first and second valve devices.

8. The at least partially electrically driven vehicle according to claim 7, further comprising a third valve device arranged such that a fluid flow starting from the first air inlet and from the second air inlet in the direction of the air outlet can be prevented by use of the third valve device.

9. The at least partially electrically driven vehicle according to claim 6, wherein each valve device of the at least one valve device is assigned an actuator which can be coupled to a control device of the air-conditioning unit for receiving an actuating signal, which defines a position of the respective each valve device.

10. The at least partially electrically driven vehicle according to claim 6, wherein the first air inlet is designed to be positioned in a manner adjoining a front hood of the vehicle.

11. The at least partially electrically driven vehicle according to claim 6, wherein the air-conditioning unit has a control device designed to output an actuating signal, which defines a position of the at least one valve device, to at least one actuator which is assigned to the at least one valve device.

12. The at least partially electrically driven vehicle according to claim 7, further comprising at least one temperature sensor coupled to the control device and designed to transmit temperature measurement values to the control device, wherein the control device is designed to receive at least one user input from a human/machine interface, and wherein the control device is further designed to provide the actuating signal to the at least one actuator depending on the user input and the received temperature measurement values.

13. A method for operating a system that comprises:
an air-conditioning unit for an at least partially electrically driven vehicle; and
an air-guiding device which is fluidically coupled to the air-conditioning unit, wherein the air-guiding device comprises:
a first air inlet;
a second air inlet;
an air outlet;
a channel fluidically coupled to the first air inlet, to the second air inlet, and to the air outlet; and
at least a first and a second valve device, wherein:
the first valve device is arranged such that a fluid flow starting from the first air inlet in the direction of the air outlet can be prevented by use of the first valve device;
the second valve device is arranged such that a fluid flow starting from the second air inlet in the direction of the air outlet can be prevented by use of the second valve device; and
each of the first and second valve devices is assigned an actuator, which is coupled to a control device of the air-conditioning unit for the purpose of receiving an actuating signal, which defines a position of the respective first and second valve devices, and wherein the method comprises steps of:
outputting an actuating signal to the actuator that is assigned to the first valve device in such a way that only the fluid flow starting from the first air inlet in the direction of the air outlet is prevented by use of the first valve device for a heating mode of the air-conditioning unit; or
outputting a different actuating signal to the actuator that is assigned to the second valve device in such a way that only the fluid flow starting from the second air inlet in the direction of the air outlet is prevented by use of the second valve device for a cooling mode of the air-conditioning unit.
